(19) United States
(12) Patent Application Publication
(10) Pub. No.: US 2003/0006081 A1
(43) Pub. Date: Jan. 9, 2003

(54) Drive train and steering method and apparatus for race trucks

(76) Inventors: David Burke, Dewinton (CA); Pierre Guyon, Calgary (CA)

Correspondence Address: John Russell Uren, P. Eng., Suite 202, 1590 Bellevue Avenue, West Vancouver, BC, V7V 1A7, CA

(21) Appl. No.: 09/898,916

(22) Filed: Jul. 3, 2001

(51) Int. Cl. B60K 17/34; B62D 5/06

(52) U.S. Cl. 180/233; 180/417

(57) ABSTRACT

An all terrain vehicle or “mini-monster” truck for use in off road operations or for entertainment applications such as racing activities. The vehicle has a drive system which utilizes a normally operated front wheel drive engine mounted within the frame of the vehicle. The transmission connected to the engine has its first drive shaft extending forwardly to a forward differential which powers the forward wheels. The second drive shaft extends rearwardly and powers a rearward differential which powers the rearward wheels. A hydraulic steering system allows each of the forward and rearward wheel pairs to turn dependently or independently of the other wheel pair. The usual transmission differential is locked to provide constant torque to both the front and rear differentials.

### INTRODUCTION

This invention relates to a drive train and a steering system for trucks and, more particularly, to a drive train and steering system for trucks which may find particular use in racing and other entertainment applications.

### BACKGROUND OF THE INVENTION

In recent years, truck racing has seen a rise in popularity and such races and related exhibitions are held nationally and internationally. The races may take place around a fixed circuit similar to a racetrack used for car racing or the circuit may include obstacles which the truck must climb or otherwise overcome during the race. The trucks used for this latter type of racing are generally known as “monster” trucks and have substantially oversized wheels and engines, the engines sometimes producing 1500 HP and being of a displacement over 500 cu. in. Oversized tires are mounted on the wheels, the axles to which the wheels are attached being all driven by shafts emanating from a transaxle in a four wheel type drive arrangement.

The drive arrangement used is generally common in such oversized or monster trucks. The drive arrangement consists of the usual engine mounted lengthwise with a transmission connected to the rear of the engine which transmission is powered by a drive shaft from the engine through a clutch. The transmission, in turn, drives a transaxle mounted adjacent the transmission. The transaxle powers two drive shafts extending therefrom, one of the drive shafts extending to a first differential on the forward end of the truck and a second drive shaft extending to a second differential on the rearward end of the truck. Each differential has two drive shafts or drive axles extending therefrom which are connected to wheels associated therewith. Thus, the commonly known four wheel drive configuration for such trucks is obtained. If an automatic transmission is used as is also common, a torque converter is provided between the engine and the transmission but, otherwise, the four wheel drive configuration is similar.

The use of transaxles in addition to a transmission is disadvantageous since transaxles add components which are expensive to obtain and to service. The drive shaft configuration and gearing is complex and sophisticated, particularly when such transaxles are used for four wheel drive type racing.

The steering system in such race trucks is also of interest. In general, racing trucks have steering systems which allow steering only of the forwardly mounted wheels. Some such racing trucks further have steering systems which allow steering of the rearward mounted wheels but in association and symmetrically with the steering of the forward wheels. While such steering is generally satisfactory, it is limiting since there are many conditions both during races or entertainment and when the vehicle may be off road, where additional steering and truck movement flexibility is desired by allowing steering of each of the forward and rearward set of wheels independent of the steering of the other set of wheels.

It will be appreciated that the so-called “monster” trucks which have been referred to as being exhibited and raced are expensive to build and maintain. Ownership and racing of such monster trucks is not a realistic option for the typical race fan viewing these events which is disadvantageous if wide participation of the racing fan and close identification of the truck racing is desired.

### SUMMARY OF THE INVENTION

According to one aspect of the invention, there is provided a drive system for an all terrain vehicle comprising an engine with a drive shaft, a transmission connected to said engine and having a differential driven by said transmission, first and second drive shafts extending therefrom and driven by said transmission differential, a first differential connected to said first drive shaft, a second differential connected to said second drive shaft and a pair of drive axles extending from said first and second differentials with wheels mounted on one end of each of said pair of drive axles.

According to a further aspect of the invention, there is provided a steering system for a vehicle having a forward and rearward set of wheels mounted on said vehicle, said steering system comprising a hydraulic pump powered from an engine of said vehicle, a steering member being rotatable by a user, a first valve operably associated with said steering member, second and third valves being manually operable by said user, a first hydraulic cylinder connected between said forward set of wheels and being operable to rotate said forward set of wheels simultaneously about respective vertical axes for each of said forward wheels, a second hydraulic cylinder connected between said rearward set of wheels and being operable to rotate said rearward set of wheels simultaneously about respective vertical axes for each of said rearward wheels, said second and third valves being operable to direct hydraulic fluid to either or both of said first and second hydraulic cylinders so as to independently rotate each of said forward and rearward sets of wheels about said generally vertically extending axes.

According to yet a further aspect of the invention, there is provided a racing vehicle with a drive system according to the aforementioned invention.

According to still yet a further aspect of the invention, there is provided a racing vehicle with a steering system according to the aforementioned invention.

### BRIEF DESCRIPTION OF THE SEVERAL VIEWS OF THE DRAWINGS

Specific embodiments of the invention will now be described, by way of example only, with the use of drawings in which:

FIG. 1 is a diagrammatic side view of the racing vehicle or mini-truck according to one aspect of the present invention;

FIG. 2 is a diagrammatic front view of the racing vehicle or mini-truck of FIG. 1;

FIG. 3 is an enlarged diagrammatic side view particularly illustrating the engine, the transmission attached thereto with its associated transmission differential, and the drive shafts extending from the transmission differential and being attached to forwardly and rearwardly located differentials according to the invention;

FIG. 4 is diagrammatic view of the hydraulic circuitry used for the steering system of the vehicle according to a further aspect of the invention; and

FIG. 5 is a diagrammatic view illustrating the several positions of the steering system valves used with the hydraulic circuitry of FIG. 4 in order to obtain desired steering of the forward and rearward wheels of the vehicle.

### DESCRIPTION OF SPECIFIC EMBODIMENT

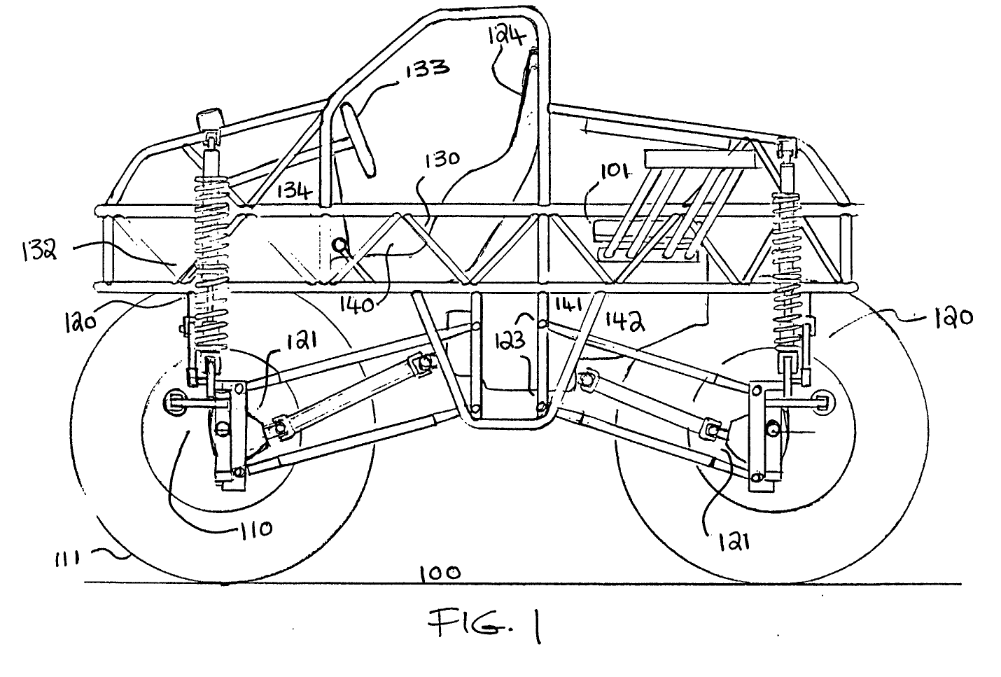

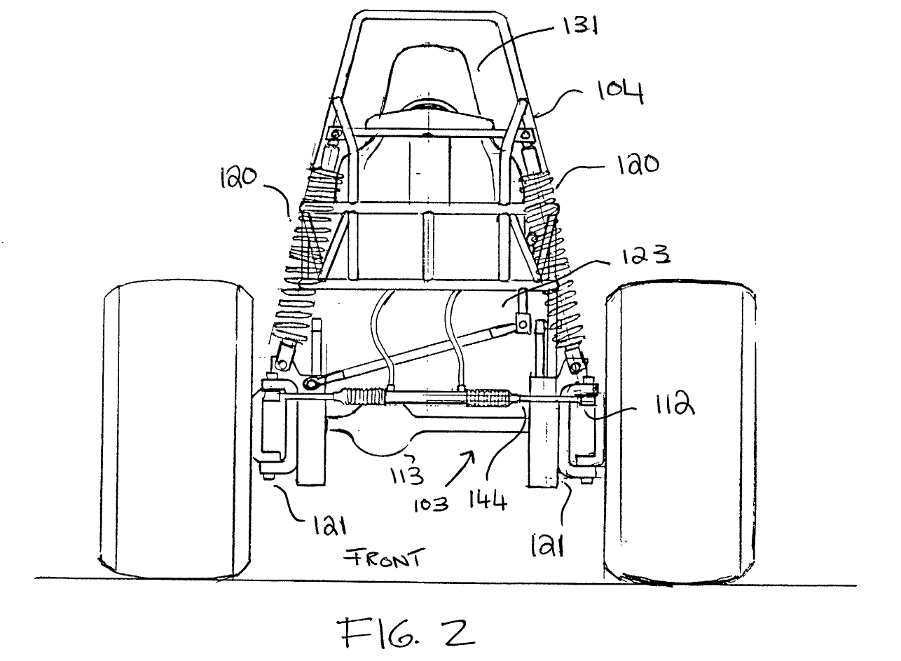

A vehicle, according to the invention is generally illustrated at 100 in FIG. 1. It takes the form of an ATV or “mini-truck” type vehicle and may be conveniently used for racing or other entertainment purposes. The vehicle 100 comprises an engine generally illustrated at 101, a drive system generally illustrated at 102 and explained in greater detail hereafter, a steering system generally illustrated at 103 in FIG. 2 and explained in greater detail hereafter and a tubular frame 104 which supports and generally surrounds the various components which make up the vehicle 100.

The vehicle 100 is a four-wheel drive type vehicle; that is, the drive system 102 includes four wheels 110 with tires 111 mounted thereon. Each wheel 110 is connected to a drive axle 112 (FIG. 2) and each drive axle 112 is connected to a differential 113 comprising forward and rearward mounted differentials 113. Each of the differentials 113 is connected to a respective drive shaft 114, 115 which, in turn, are each connected to the transaxle associated with transmission 120. The transaxle includes a transmission differential which is modified for the current application by being “locked” so that there is equal torque applied to each of the drive shafts 114, 115 and no slippage occurs as is otherwise usual. Transmission 120 is connected to the engine 101 of the vehicle 100 through a torque converter if the transmission is an “automatic” transmission or through a clutch if the transmission is manual.

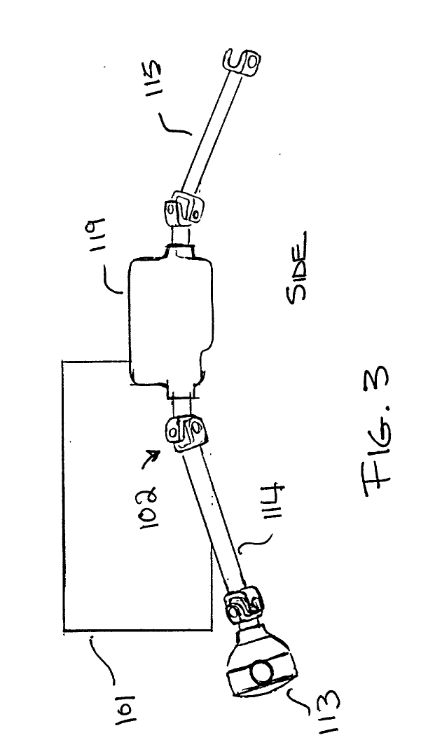

The engine 120 used as power for the transmission 120 is conveniently a front wheel drive 1600 cc. engine as used in the HONDA CIVIC (™) automobile although other such engines can also be used. Because of the popularity of the car, such engines are readily available at nominal cost. The engine 101, however, is specially mounted and otherwise adapted for use in vehicle 100. To that end, the engine 101 is mounted with the axis of its crankshaft lengthwise in the vehicle 100 as opposed to its usual sidewise mounting when used in the usual front wheel drive type automobile configuration. In such a position and whereas with reference to FIG. 3, the transmission 120 would be normally mounted such that the drive shafts 114, 115 extend from the transmission laterally or normal to the longitudinal axis of the automobile in which the engine 101 was normally used, the transmission 120 and its associated transmission differential or transaxle is now in a position wherein it is rotated 90 degrees and the drive shafts 114, 115 extend longitudinally with and parallel to the longitudinal axis of the vehicle 100 where they each and connect with respective forward and rearward differentials 113 as described.

The usual suspension components for racing are provided on vehicle 100. A plurality, namely four, shock absorbers 120, are mounted between the tubular frame 104 of the vehicle 100 and wheel brackets 121 which are connected to the wheels 110. Suspension struts 122 (only two of which are shown in FIG. 1) extend between the frame 104 and the wheel brackets 121. The struts 122 provide for connection integrity of the vehicle and rotate about the connection points 123 to allow for vertical movement of the wheel brackets 121 and the attached wheels 110 and tires 111 during vehicle movement. To enhance lateral stability of the vehicle 100, a further suspension strut 123 extends between the frame 104 and the wheel bracket 121 (FIG. 2). An operators seat 124 is provided and a gearshift lever 130, conveniently a gearshift lever to select the correct drive configuration from the automatic transmission 119, is positioned close to the operators's seat 124 for access by the operator. The usual engine operating gauges 131 are mounted in front of the operators seat 124 for direct viewing by the operator. A footpedal (not shown) is mounted on the right hand of the operators cockpit wherein the seat 124 is positioned and a brake footpedal (not shown) is mounted on the left hand side of the operators cockpit.

A steering wheel 133 is removably connected to an orbital or first valve 134 and a manually operable second and third hydraulic valve 140, 141 respectively, together with steering wheel 133, are all mounted convenient to the operators seat 124. These components 133, 134, 140 and 141 are used in association with the steering of the vehicle 100 and which operation will be described in greater detail hereafter.

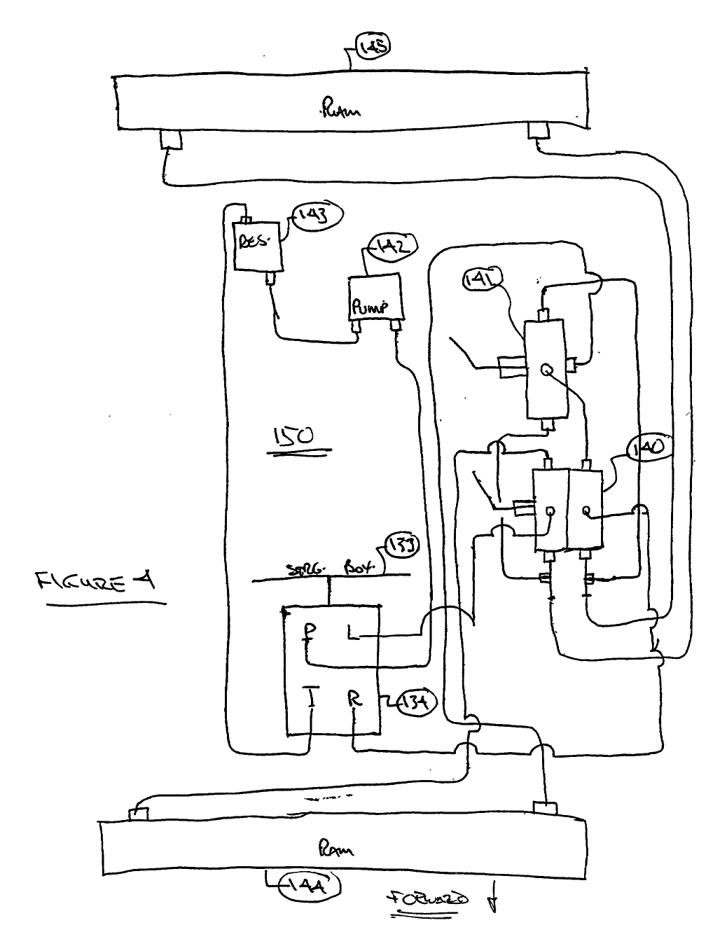

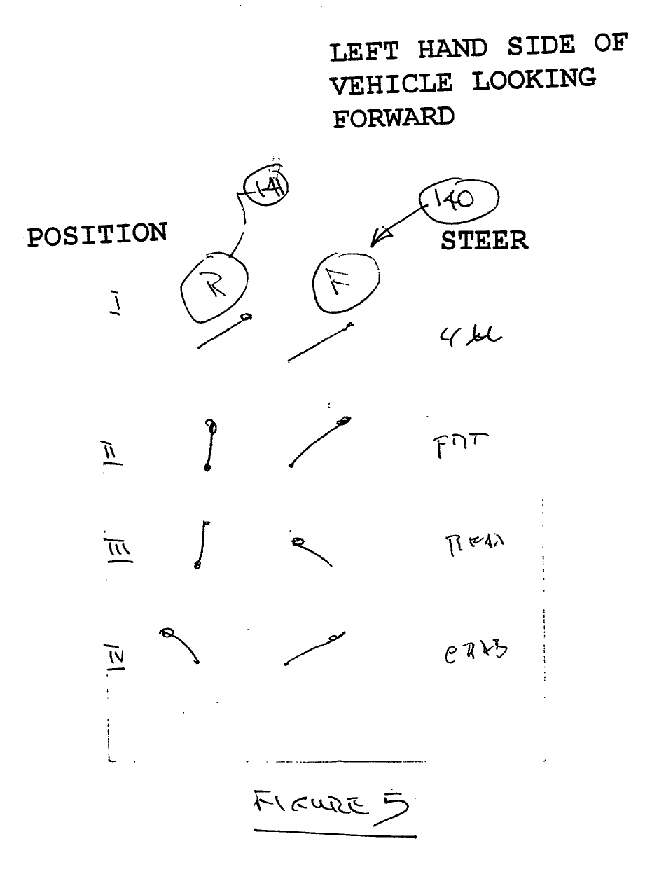

The steering circuit is hydraulic and is shown in detail in FIGS. 4 and 5. A hydraulic pump 142 is mounted on the rearward end of engine 101 (FIG. 1). Pump 142 is connected to a reservoir or tank 143 and to the orbital or first valve 134 which is under control of the steering wheel 133 as to how much fluid is provided to the hydraulic cylinders 144, 145 used for steering the front and rear set of wheels 110, respectively. However, second and third valves 140, 141 are operated to control which of the two set of wheels 110 is steered and in what direction they are steered.

The operator's layout is illustrated with reference to FIG. 5 with the forward end of the vehicle being denoted as the lower area of the figure. Second or forwardly located valve 140 has two(2) operating positions and third or rearwardly located valve 141 has three(3) operating positions. If the handles of both valves 140, 141 are pulled fully back as shown in Position I, fluid will flow to both of the hydraulic cylinders 144, 145 and will direct fluid to the hydraulic cylinders 144, 145 such that both the forward and rearward set of wheels 110 will turn in the same direction; i.e., that the wheels 110 will both rotate about a vertical axis in the same direction being either clockwise or counterclockwise according to the position of the steering wheel 133. If the handle of third or rearward valve 140 is in the neutral position and the second or forward valve 141 is in the rearward position as is illustrated in Position II, there will be no fluid supplied to either side of rearward hydraulic cylinder 145 and the vehicle 100 will be guided with forward steering only from hydraulic cylinder 144. If the handle of rearward or third valve 140 is in the neutral position and the handle of forward or second valve 141 is in the forward position as illustrated in Position III, no fluid will be supplied to forward hydraulic cylinder 144 but fluid will continue to be supplied to rearward hydraulic cylinder 145 so that only the rear wheels 110 provide guidance and steering to the vehicle 100 in accordance with the rotation of steering wheel 135. Finally, if the handle of third or rearward valve 140 is fully forward and the handle of second or forward valve 141 is fully backward as diagrammatically illustrated at Position IV, fluid will be supplied to both the forward and rearward hydraulic cylinders 144, 145 but on opposite sides so that the wheels 110 will rotate responsive to rotation of the steering member 133 about respective vertical axes but in opposite directions so that an unusual crab type vehicle movement is obtained when the vehicle 100 is underway during operation.

It will therefore be seen that the forward and rearward set of wheels 110 may take one of four different steering configurations thereby allowing the vehicle 100 to move in four different ways. This provides enhanced flexibility and/or interesting vehicle configurations when underway which are useful in allowing safe operation and providing enhanced entertainment value.

### Operation

In operation, it will be assumed that the vehicle 100 is at rest and that it is desired to commence vehicle movement in a crab type configuration when the vehicle 100 is underway.

The operator will commence operation of the vehicle 100 by starting the engine 101. The transmission or gearshift lever 130 will remain in the PARK or NEUTRAL position. In the first operating configuration, the handle of the forward valve 140 will be pulled fully forward and the handle of the rearward valve 141 will be pushed fully back both as viewed in Position IV of FIG. 5. The operator will then move the gearshift lever 131 to the DRIVE position. Power is provided to the wheels 111 from the engine 101, transmission and locket transmission differential 119 through the drive shafts 114, 115 and front and rearward located differentials 121 when the operator depresses the accelerator pedal. Steering wheel 133 will be rotated as desired and the vehicle 100 will move forwardly with the forward wheels 110 tending to move the vehicle 100, for example, to the right or clockwise condition about a vertical axis and the rearward wheels 110 tending to move the vehicle to the left or similarly clockwise condition about a vertical axis. A crab type vehicle movement configuration will therefore be obtained during movement.

The configuration of the vehicle 100 during movement way be varied substantially between all four operating positions of the forwardly and rearwardly located levers 140, 141 as described. The engine 101 will continuously be providing power through a torque converter to transmission 119 and this power will be transferred through the locked transmission differential and drive shafts 114, 115 to the forward and rearward located differentials 113. The differentials 113 will provide power to the drive axles 112 extending therefrom in a continuous four wheel drive movement although the rotation of wheels 110 will be, of course, in one of the four(4) different configurations described with respect to and illustrated in FIG. 5.

Many modifications will readily occur to those skilled in the art to which the invention relates. For example, while the configuration of the steering condition of the forward and rearward wheels is currently done visually through operator inspection, gauges or lights are conveniently provided which would reflect the steering configuration and be easily observable by the operator without the necessity of the operator making actual visual inspection of the wheels themselves. Similarly, while power is continuously provided to the four wheels so as to obtain a continuous four wheel drive configuration, it would be possible to provide controls to either or both of the differentials 113 in order to allow only rear wheel drive or, alternatively, front wheel drive only.

The vehicle 100 described and illustrated has been designed with a principal view towards its use in truck or “mini-monster” type truck racing as opposed to the so-called “monster” truck racing. The different steering configurations obtained from the hydraulic steering system 150 provide primarily for entertainment value when the vehicle 100 is operated in the various configurations although under specific racing conditions, it may be found that some steering configurations are more valuable than others. However, it is also contemplated that the vehicle 100 may be used as an off road or all terrain type vehicle (ATV) and, in that event, some of the steering configurations may be particularly valuable during off road operations.

The use of a readily available front wheel drive engine positioned as described so as to allow four wheel drive operation of an ATV is particularly convenient since the additional transaxle manually used in four wheel drive vehicles may not be required and the engine is simply converted from an engine used for front wheel drive to an engine used for four wheel drive. Many such engines are commercially available since the automobiles normally powered by such engines tend to be less expensive and sold widely.

Many further modifications will readily occur to those skilled in the art to which the invention relates and the particular embodiments described should be taken as illustrative of the invention only and not as limiting its scope as defined in accordance with the accompanying claims.

We claim:

1. A drive system for an all terrain vehicle comprising an engine with a drive shaft, a transmission connected to said engine and having a transmission differential driven by said transmission, first and second drive shafts extending therefrom and being driven by said transmission differential, a first differential connected to said first drive shaft, a second differential connected to said second drive shaft and a pair of drive axles extending from said first and second differentials with wheels mounted on one end of each of said pair of drive axles.

2. A drive system as in claim 1 wherein said engine has a crankshaft with a longitudinal axis within said engine, said engine being positioned within said vehicle, said vehicle having a longitudinal axis running generally forwardly and rearwardly of said vehicle, said longitudinal axis of said crankshaft being parallel to said longitudinal axis of said vehicle.

3. A drive system as in claim 2 wherein said vehicle is an all terrain vehicle.

4. A drive system as in claim 2 wherein said vehicle is a “mini-monster” truck.

5. A drive system as in claim 2 wherein said engine is an engine normally used for front wheel drive vehicles.

6. A drive system as in claim 5 wherein said transmission is an automatic transmission having PARK, DRIVE and REVERSE configurations and further comprising a torque converter between said engine and said automatic transmission.

7. A drive system as in claim 6 wherein at least one of said first and second drive shafts telescopes between said transmission and said respective one of said first or second differentials connected to said transmission.

8. A drive system as in claim 1 and further comprising a steering system wherein said wheels comprise forward and rearward ones of said wheels, said steering system comprising a hydraulic pump powered from said engine of said vehicle, a steering member being rotatable by a user, a first valve operated by said rotation of said steering member, a second and third valve manually operable by said user, a first hydraulic cylinder connected between said forward ones of said wheels and being operable to rotate said forward ones of said wheels simultaneously about respective vertical axes, a second hydraulic cylinder connected between said rearward ones of said wheels and being operable to rotate said rearward ones of said wheels about respective vertical axes, said first valve being operable to direct hydraulic fluid to either or both of said first and second hydraulic cylinders.

9. A steering system for a vehicle having a forward and rearward set of wheels mounted on said vehicle, said steering system comprising a hydraulic pump powered from an engine of said vehicle, a steering member being rotatable by a user, a first valve operably associated with said steering member, second and third valves being manually operable by said user, a first hydraulic cylinder connected between said forward set of wheels and being operable to rotate said forward set of wheels simultaneously about respective vertical axes, a second hydraulic cylinder connected between said rearward set of wheels and being operable to rotate said rearward set of wheels simultaneously about respective vertical axes, said second and third valves being operable to direct hydraulic fluid to either or both of said first and second hydraulic cylinders so as to independently rotate each of said forward and rearward sets of wheels about said generally vertically extending axes.

10. A steering system as in claim 8 wherein said second valve allows termination of fluid flow to each of said first and second hydraulic cylinders in a first configuration, said second valve allowing fluid flow to each of said hydraulic cylinders in a first direction in a second configuration and said second valve allowing fluid flow to each of said hydraulic cylinders in a reverse direction from said first direction in a third configuration.

11. A steering system as in claim 10 wherein said forward and rearward wheels are turned in the same direction by said hydraulic cylinders when said first and second valves are in said first configuration.

12. A steering system as in claim 10 wherein said front wheels only are turned when said first and second valves are in said second configuration.

13. A steering system as in claim 10 wherein said rear wheels only are turned when said first and second valves are in said third configuration.

14. A steering system as in claim 13 wherein said forward wheels are turned in a first direction and said rearward wheels are turned in a second direction when said first and second valves are in said fourth configuration.

15. A steering system as in claim 9 wherein said vehicle is used for racing and/or entertainment.

16. A steering system as in claim 9 wherein said vehicle is an off road vehicle.

17. A steering system as in claim 9 wherein said vehicle is a “mini-monster” truck.

18. A steering system as in claim 16 wherein said off road vehicle is an all terrain vehicle.
